(19) United States
(12) Patent Application Publication
(10) Pub. No.: US 2011/0179667 A1
(43) Pub. Date: Jul. 28, 2011

(54) FREEZE DRYING SYSTEM

(76) Inventors: Ron C. Lee, Bloomsbury, NJ (US); Prerona Chakravarty, New Providence, NJ (US)

(21) Appl. No.: 12/882,337

(22) Filed: Sep. 15, 2010

Related U.S. Application Data
(60) Provisional application No. 61/243,178, filed on Sep. 17, 2009.

(51) Int. Cl. F26B 5/06; F26B 5/04

(52) U.S. Cl. 34/287; 34/284; 34/298

(57) ABSTRACT

A method for distributing a cryogenic fluid inside a freeze drying chamber. The cryogenic fluid is fed into the freeze drying chamber through a venturi device. The cryogenic fluid will form an ice fog which will be rapidly and uniformly distributed throughout the freezing chamber and into the vials present in the freezing chamber.

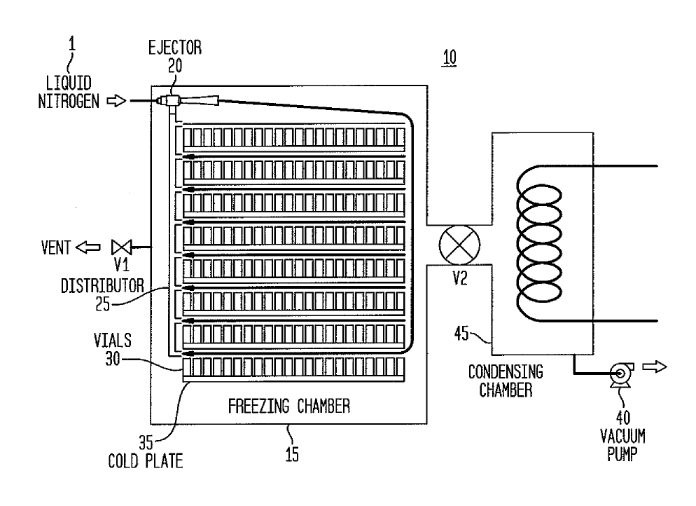

This application claims priority from provisional application U.S. Ser. No. 61/243,178 filed Sep. 17, 2009.

### BACKGROUND OF THE INVENTION

The invention is directed towards a method and apparatus for freeze drying. More particularly, the invention is directed to a method and apparatus for freeze drying by improving the uniformity of freezing and ice nucleation during the initial freezing phase.

A typical pharmaceutical freeze drying or lyophilization system involves the freezing and subsequent freeze drying of hundreds to thousands of small vials containing the typically aqueous based product to be processed. The freezing is typically accomplished by passing a refrigerant through the cold plates upon which the vials are placed; however, the temperature at which the freezing occurs can vary widely from vial to vial. While there is a maximum temperature at which freezing will occur (0° C. for pure water), the minimum temperature can be 10 to 20 degrees Celsius or more below 0° C. This difference between the equilibrium freezing point and the temperature at which ice crystals first form in the sample is known as the degree of supercooling. This supercooling varies from vial to vial and causes variation in the freeze dried product, increased freezing and primary drying time. Further potentially degraded product quality can result because of smaller than desired ice crystals which form at large degrees of supercooling. A high degree of supercooling produces a greater number of small ice crystals and results in smaller pore sizes in the freeze dried product. This in turn increases product resistance and primary drying time since smaller pores restrict vapor flow.

In scale-up from laboratory to production (i.e., “dirty” to sterile environment) nucleation can occur at much lower temperatures causing greater supercooling and extended primary drying times. Additionally, due to inter-vial variability in nucleation temperatures, vials with a lower degree of supercooling may finish primary drying first and be negatively impacted by overheating. Variability in freezing is a significant scale-up problem because a freezing procedure optimized in the laboratory may not transfer exactly to a manufacturing scale. The extension in primary drying time is usually the more serious problem, particularly if unrecognized and fixed cycle times are used. It is thus important to be able to control the nucleation temperature in order to control resistance and drying times.

A method widely used in commercial freeze dryers to remove variations in pore size and drying behavior is annealing. During annealing, a phenomenon called Oswald ripening occurs wherein larger ice crystals form at the expense of smaller ones leading to a product with larger pore size and shorter primary drying times. Annealing is not suitable for heat labile and protein based formulations (W. Wang: International Journal of Pharmaceutics 203 (2000) 1-60). In such scenarios, the ability to control the nucleation temperature to ensure product homogeneity is of paramount importance.

One approach for improving the uniformity of freezing, as well as freezing at the desired degree of supercooling which is typically at as high a temperature as possible, is to introduce nucleating particles. A particularly advantageous nucleating particle is water ice for aqueous based products in the form of an ‘ice fog’ introduced into the freezing chamber. Such a process is described in Rambhatla et al. “Heat and Mass Transfer Scale-up Issues During Freeze Drying: II. Control and Characterization of the Degree of Subcooling”, AAPS PharmaSciTech 2004; 5(4). The concept of temperature controlled ice nucleation was earlier suggested by T. W. Rowe in 1990 (International Symposium on Biological Product Freeze-Drying and Formulation; Geneva, Switzerland). Cold nitrogen gas is introduced into a humidified environment inside the freeze drying chamber to form an ice fog after the vials have achieved the temperature at which nucleation is desired. The ice crystals subsequently make their way into the vials, possibly aided by an increase in chamber pressure, and induce nucleation inside the vial. Although this technique has found success on a laboratory scale, it has proven difficult to scale up to commercial freeze dryers. The difficulty is not only forming the ice fog, but also uniformly distributing the ice fog rapidly throughout the freezing chamber to ensure all vials are properly seeded with nucleating ice particles.

The invention provides an improvement over the ‘ice fog’ method for producing uniformly frozen products during the initial phase of freeze drying by rapidly and uniformly distributing the ice fog throughout the freezing chamber.

### SUMMARY OF THE INVENTION

In one embodiment of the invention there is disclosed, a method for freeze drying comprising feeding a cryogenic fluid through a venturi device into a freeze drying chamber.

In another embodiment of the invention, there is disclosed a method of feeding a cryogenic fluid into a freeze drying chamber comprising feeding the cryogenic fluid into a venturi device.

In a further embodiment of the invention, there is disclosed a method of distributing a cryogenic fluid throughout a freeze drying chamber comprising feeding the cryogenic fluid through a venturi device.

In yet another embodiment of the invention, there is disclosed a method of forming an ice fog in a freeze drying chamber comprising feeding a cryogenic fluid through a venturi device into the freeze drying chamber.

In yet a further embodiment, there is disclosed a method for providing a uniform dispersion of nucleating ice crystals in a freeze drying chamber comprising feeding a cryogenic fluid into a venturi device into the freeze drying chamber.

In a different embodiment of the invention, there is disclosed an apparatus comprising a freeze drying chamber and a venturi device. The venturi device may be any venturi device such as an ejector.

The cryogenic fluid may be any type of cryogenic fluid such as liquid nitrogen, oxygen, air, argon and mixtures of these. The cryogenic fluid used to drive the venturi device may be in a liquid, vapor or two-phase condition. The pressure of the cryogenic fluid can be any pressure greater than the pressure of the freezing chamber with 1 to 10 bar above freezing chamber preferred.

The nucleating ice crystals may be formed from any suitable condensable vapor, including water or other gases. The condensable vapor such as water vapor may be introduced by any mechanism, either before or during the ice fog formation, and may be introduced directly into or downstream of the venturi device.

The cryogenic fluid, steam or other fluids introduced into the freezing chamber may be suitably processed, such as by filtration and other techniques, to produce sterile fluids.

The cold gas generated by the process including the presence of the ice fog, as well as the rapid and uniform distribution of cold gas/ice fog, may be used in other steps of the freeze drying process to facilitate uniformity and/or the rate of cooling.

A variety of venturi devices may be employed in the invention as well as multiple venturi devices used together to facilitate uniform distribution. Additional flow distribution devices such as distribution pipes and turning vanes may also be employed.

A variety of pressure variations through the freezing process and/or nucleating ice step are possible beyond those earlier stated.

The products to be freeze dried may be of any type and may be contained in any configuration within the freezing chamber including vials, trays or other types or combinations of containers.

The ice fog is typically formed when a cryogenic fluid contacts a humid gas or suitable condensable vapor. The humidity freezes out and generates a dispersion of small ice nuclei. The source of the humidity may be any suitable source but it is typically water.

### BRIEF DESCRIPTION OF THE DRAWINGS

The FIGURE is a schematic illustration of a freeze drying system employing the method of the invention.

### DETAILED DESCRIPTION OF THE INVENTION

Turning to the FIGURE, a typical freeze drying system 10 is depicted. The apparatus and method of the invention is also depicted wherein the suction of the venturi device 20 is connected to a distributor 25, and the discharge delivers a mixed cooling fluid into the freezing chamber 15. Other arrangements of the distribution piping are possible, including distributor piping at the discharge of the venturi device. The venturi device here is an ejector but other venturi devices can be employed in the invention. The vials 30 containing the product to be freeze dried are placed on the cold plates 35 inside the freezing chamber. The initial phase of the freezing process is generally conducted at atmospheric pressure and the vials are generally cooled to a suitable temperature at or below their maximum freezing point temperature. Not shown is a means to provide humidified atmosphere within the freeze drying chamber, which may be from the moisture normally contained in atmospheric air, or artificially introduced through the injection of steam, a moisture vapor containing gas, or alternative humidification means. Alternatively the moisture may be partially or totally introduced directly into or downstream of the venturi device 20.

When the suitable vial temperature is achieved, liquid nitrogen 1 at an elevated pressure is introduced into the venturi device, in this case ejector 20. The ejector 20 serves two purposes. First, it provides an extremely efficient means for cooling the humidified air within the chamber and forming the ice fog. Second, the suitably sized ejector provides a pumping capacity that can provide a circulation of the ice fog throughout the freezing chamber 15 very rapidly. It is a significant advantage that the ejector can accomplish both these functions without introducing any moving parts or other complicated mechanisms that would be difficult to steam or otherwise sterilize. One arrangement for the ejector is shown in the FIGURE which introduces a distributor 25 which creates a negative pressure that draws the ice fog throughout the system 10 and the multiple shelves or cold plates 35. Multiple ejectors can also be employed as well as providing the ejector 10 at other positions around the freezing chamber.

During the formation of the ice fog, the distribution of the nucleating ice crystals into each vial can be facilitated by the simultaneous or subsequent pressurization of the chamber. This pressurization forces gas containing the ice crystals into each vial. This pressurization may be accomplished by a variety of means, and may be facilitated by performing a depressurization of the freezing chamber through the use of a vacuum pump 40 before beginning the ice fog formation. Self-pressurization of the chamber is possible simply by the introduction of the vaporizing liquid nitrogen 1 where vent valve V1 is closed. Valve V2 is opened and the vacuum pump 40 draws the gas through a condensing chamber 45. Alternatively, additional gas such as air or nitrogen may be introduced into the chamber to increase the chamber pressure. Both methods of pressurization can also be employed in tandem. Additionally, rapid depressurization following the ice fog introduction may be used to improve the nucleating phenomenon.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

1. A method for freeze drying comprising feeding a cryogenic liquid through a venturi device into a freeze drying chamber.

2. The method as claimed in claim 1 wherein said venturi device is an ejector.

3. The method as claimed in claim 1 wherein said cryogenic fluid is selected from the group consisting of liquid nitrogen, oxygen, air, argon and mixtures of these.

4. The method as claimed in claim 1 wherein said cryogenic fluid is a liquid, vapor or two-phase condition.

5. The method as claimed in claim 1 wherein said freeze drying is of a condensable vapor.

6. The method as claimed in claim 5 wherein said condensable vapor is introduced into said freeze drying chamber directly into or downstream of said venturi device.

7. The method as claimed in claim 6 wherein said condensable vapor is introduced into said freeze drying chamber before or during ice fog formation.

8. A method of distributing a cryogenic fluid throughout a freeze drying chamber comprising feeding the cryogenic fluid through a venturi device.

9. The method as claimed 8 wherein said venturi device is an ejector.

10. The method as claimed in claim 8 wherein said cryogenic fluid is selected from the group consisting of liquid nitrogen, oxygen, air, argon and mixtures of these.

11. The method as claimed in claim 8 wherein said cryogenic fluid is a liquid, vapor or two-phase condition.

12. The method as claimed in claim 8 wherein said freeze drying is of a condensable vapor.

13. The method as claimed in claim 12 wherein said condensable vapor is introduced into said freeze drying chamber directly into or downstream of said venturi device.

14. The method as claimed in claim 13 wherein said condensable vapor is introduced into said freeze drying chamber before or during ice fog formation.

15. A method of forming an ice fog in a freeze drying chamber comprising feeding a cryogenic fluid through a venturi device into the freeze drying chamber.

16. The method as claimed in claim 15 wherein said venturi device is an ejector.

17. The method as claimed in claim 15 wherein said cryogenic fluid is selected from the group consisting of liquid nitrogen, oxygen, air, argon and mixtures of these.

18. The method as claimed in claim 15 wherein said cryogenic fluid is a liquid, vapor or two-phase condition.

19. The method as claimed in claim 15 wherein said freeze drying is of a condensable vapor.

20. The method as claimed in claim 19 wherein said condensable vapor is introduced into said freeze drying chamber directly into or downstream of said venturi device.

21. The method as claimed in claim 20 wherein said condensable vapor is introduced into said freeze drying chamber before or during ice fog formation.

22. The method as claimed in claim 15 wherein said ice fog is formed by contacting said cryogenic fluid with said condensable vapor.

23. A method for providing a uniform dispersion of nucleating ice crystals in a freeze drying chamber comprising feeding a cryogenic fluid into a venturi device into the freeze drying chamber.

24. The method as claimed in claim 23 wherein said nucleating ice crystals form from a condensable vapor.

25. The method as claimed in claim 24 wherein said condensable vapor is water.

26. The method as claimed in claim 23 wherein said venturi device is an ejector.

27. The method as claimed in claim 23 wherein said cryogenic fluid is selected from the group consisting of liquid nitrogen, oxygen, air, argon and mixtures of these.

28. The method as claimed in claim 23 wherein said cryogenic fluid is a liquid, vapor or two-phase condition.

29. The method as claimed in claim 23 wherein said freeze drying is of a condensable vapor.

30. The method as claimed in claim 29 wherein said condensable vapor is introduced into said freeze drying chamber directly into or downstream of said venturi device.

31. The method as claimed in claim 30 wherein said condensable vapor is introduced into said freeze drying chamber before or during ice fog formation.

32. The method as claimed in claim 23 wherein said ice fog is formed by contacting said cryogenic fluid with a humid gas.

33. The method as claimed in claim 1 wherein said freeze drying chamber is depressurized prior to introduction of said condensable vapor.

34. The method as claimed in claim 33 wherein said freeze drying chamber is depressurized to a pressure below atmospheric pressure.

35. The method as claimed in claim 33 wherein said freeze drying chamber self-pressurizes after introduction of said condensable vapor.

36. The method as claimed in claim 35 wherein said self-pressurization is to a pressure above atmospheric pressure.

37. The method as claimed in claim 33 wherein said freeze drying chamber is self-pressurized after the introduction of said condensable vapor.

38. The method as claimed in claim 37 wherein rapid depressurization of said freeze drying chamber occurs after introduction of the ice fog into said freeze drying chamber.

39. The method as claimed in claim 38 wherein said rapid depressurization improves nucleation within said freeze drying chamber.
